(19) United States
(12) Patent Application Publication
(10) Pub. No.: US 2012/0260421 A1
(43) Pub. Date: Oct. 18, 2012

(54) COVER FOR YOGA EQUIPMENT

(76) Inventor: Gina DeGregorio, Philadelphia, PA (US)

(21) Appl. No.: 13/447,620

(22) Filed: Apr. 16, 2012

Related U.S. Application Data
(60) Provisional application No. 61/475,488, filed on Apr. 14, 2011.

(51) Int. Cl. A47G 9/06; B32B 1/02; B65B 5/04

(52) U.S. Cl. 5/417; 53/473; 428/35.2

(57) ABSTRACT

Provided is a cover for a yoga mat. The cover has a top surface for contacting a user and a bottom surface for contacting a floor. The top and bottom surface enclose a piece of yoga equipment. The yoga mat cover may be designed to absorb sweat, prevent the spread of germs, and be machine washable.

### CLAIM TO PRIORITY

This application is based on Provisional Application Ser. No. 61/475,488, filed on Apr. 14, 2011, the disclosure of which is incorporated herein by reference and to which priority is claimed.

### BACKGROUND

Yoga is a series of mental and physical exercises which typically involve stretches or poses accompanied by controlled breathing. Poses can be done in succession, with the practitioner moving quickly from one pose to the next or holding each pose and moving slowly. Yoga is used to increase balance, strength, flexibility, and posture. Yoga may also be used to relax the body as a precursor to meditation.

Yoga can be practiced at home or in group classes. Yoga classes can be found at most gyms, exercise centers, and dedicated yoga studios. These classes are often lead by teachers who instruct students on proper technique while leading them through a series of poses. Depending on the location of the class and the teacher, different physical and spiritual aspects of practicing yoga may be emphasized. In yoga classes, it is typical for equipment to be provided for each student or practitioner, or for them to bring their own equipment. Typical yoga equipment may include a mat, a set of blocks, and a meditation blanket.

### SUMMARY

In accordance with an aspect of the invention, provided is a cover for a piece of yoga equipment. The cover includes a top layer, a bottom layer, and an interior lining opposite at least one of the top and bottom layers. The top and bottom layer are designed to create an opening therebetween to receive a piece of yoga equipment.

Another aspect of the invention is a method of using a cover for a piece of yoga equipment. The cover includes a top layer and a bottom layer. The cover is removably placed around a piece of yoga equipment.

Other aspects of the invention, including apparatus, systems, methods, and the like which constitute part of the invention, will become more apparent upon reading the following detailed description of the exemplary embodiments and viewing the drawings.

### BRIEF DESCRIPTION OF THE DRAWINGS

The accompanying drawings are incorporated in and constitute a part of the specification. The drawings, together with the general description given above and the detailed description of the exemplary embodiments and methods given below, serve to explain the principles of the invention. In such drawings:

FIG. 1 is a perspective view of a yoga mat.

FIG. 2 is a top view of an exemplary mat cover.

FIG. 3 is a top view of an exemplary yoga mat and mat cover in an open position.

FIG. 4 is a top view of an exemplary yoga mat and mat cover in a closed position.

FIG. 5 is a top view of an exemplary mat cover in a closed position.

FIG. 6 is a top view of an exemplary mat cover in an open position.

FIG. 7 is a perspective view of an exemplary block cover.

FIG. 8 is a perspective view of an exemplary block cover in an open position.

### DETAILED DESCRIPTION OF EXEMPLARY EMBODIMENT(S) AND EXEMPLARY METHOD(S)

Reference will now be made in detail to exemplary embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in connection with the exemplary embodiments and methods.

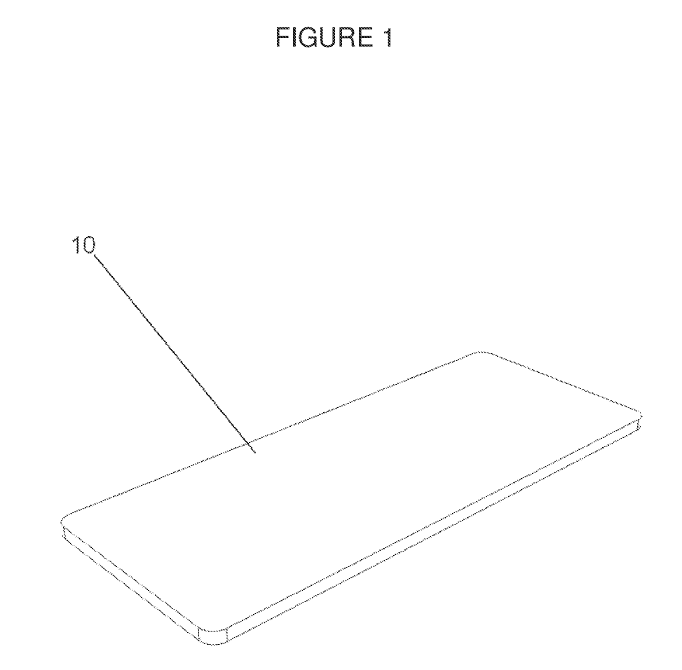

FIG. 1 depicts an exemplary yoga mat 10. Yoga studios and yoga mats 10 can be very unsanitary, harboring harmful bacteria, mold and other germs such as staph, ring worm and foot fungus. While performing yoga, practitioners touch every part of their bodies to the mats 10, exposing themselves to germs or other unsanitary conditions that may be present. When finished with a yoga session, practitioners typically roll up their mats 10 and bring them home. This can lead to the spread of germs, bacteria and viruses, which may end up causing diseases and illnesses. Yoga mats 10 are difficult to clean due to their material, size, and shape. There are non-toxic sprays on the market that are not guaranteed to kill germs or inhibit bacteria and mold. There are also antibacterial cleaners that can be used, but they contain chemicals which can lead to irritation or allergic reactions. Moreover, typical yoga mats 10 are not machine-washable or dryer-safe. Accordingly, there is a need for a method of keeping yoga mats 10 clean and sanitary, while also keeping the mat 10 grippable to the floor and to the practitioner while they are performing poses.

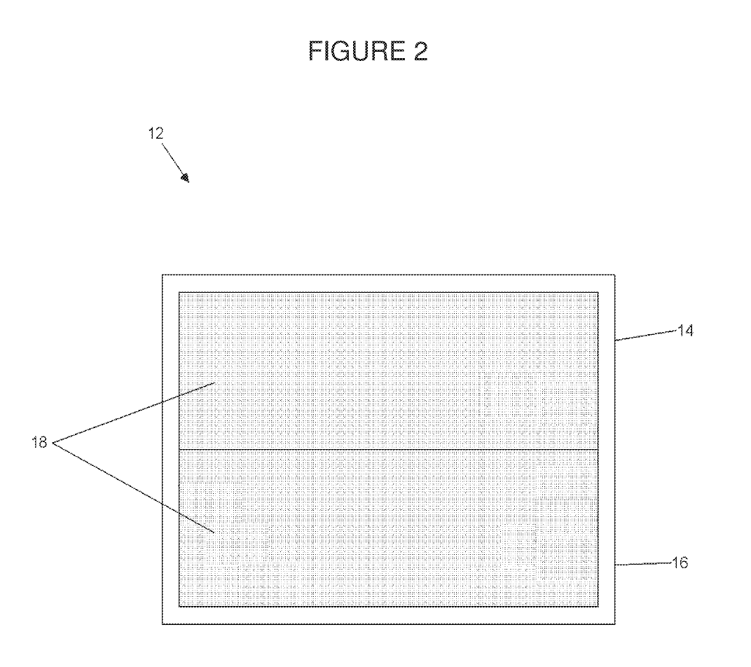

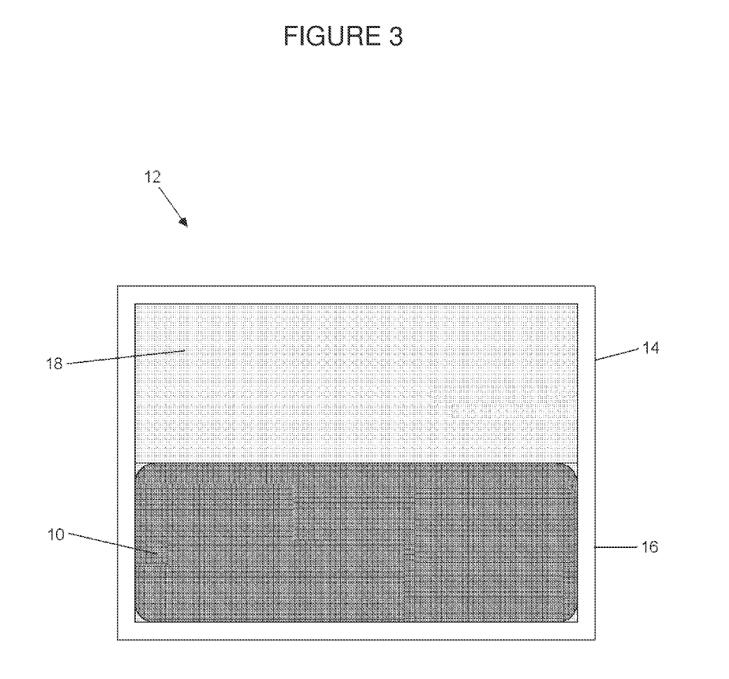

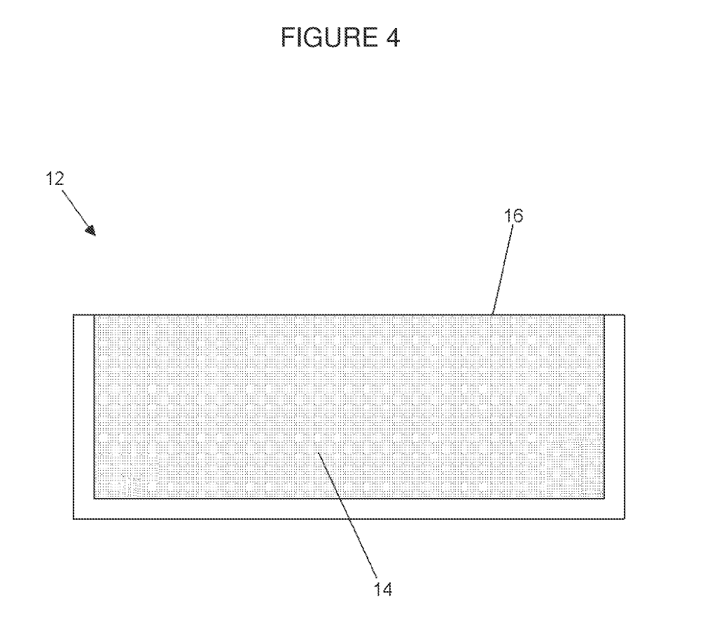

In an exemplary embodiment, a protective mat cover 12 is provided for yoga equipment. As best shown in FIGS. 2-4, the mat cover 12 may be designed to fit over or encase a yoga mat 10. The protective cover includes a top layer 14, a bottom layer 16, and an interior lining 18. The mat cover 12 may include or be made from material that is water-proof, sweat-proof, anti-bacterial, or any combination thereof. The mat cover 12 may also be eco-friendly and organic. In an exemplary embodiment the mat cover 12 is machine-washable and dryer-safe. The mat cover 12 may be a variety of sizes and may include elastic, drawstring, straps, or other means to attach or synch a larger mat cover 12 to a smaller mat 10. In various exemplary embodiments, the top layer 14, bottom layer 16, and interior lining 18 may be the same piece of material or different pieces of material connected together.

The top layer 14 and the bottom layer 16 may be permanently connected on zero to three sides. For example, the top layer 14 may be able to detach entirely from the bottom layer 16 or a single opening may be provided into which a yoga mat 10 may be inserted and removed. Two or three sides may also be separate from each other. In various exemplary embodiments, the mat cover 12 need not be rectangular as shown, and may have a variety of shapes or configurations. Any number from zero to N−1 sides may be permanently connected, where N equals the total number of sides of the mat cover 12. Accordingly, the mat cover 12 may have means to close or attach any number of non-permanently connected sides of the top layer 14 and the bottom layer 16. The mat cover 12 may close around a yoga mat 10 through a zipper, buttons, ties, hook and loop, magnet, or any other fastening method or combinations thereof. In various exemplary embodiments, the mat cover 12 does not provide fastening means so that it may be simply draped over or around the yoga mat 10.

The top layer 14 of the mat cover 12 is designed to face the user when the mat 10 is placed on the floor. The top layer 14 may be made from an absorbent material, for example an absorbent fabric, foam, or polymer material. An absorbent top layer 14 can help to absorb moisture or sweat and prevent the mat 10 from becoming slippery. It also helps prevent sweat from running off of the mat 10 and onto the surrounding floor, which can lead to unsanitary and unsafe conditions. Accordingly, any suitable material which helps prevent slipping and keeps the user or surrounding area drier than normal may be used. In an exemplary embodiment the top layer 14 includes terry cloth, though other cotton blends, synthetic fabrics, natural fabrics, moisture wicking material, etc., may be used. The top layer 14 may be the same size and shape as the mat 10, but may also be bit larger so that it can completely cover and encase the mat 10 and provide easier placement around the mat 10. It should be noted, however, that the mat cover 12 may be a different size or take a different shape than a typical yoga mat 10. The top layer 14 may also be provided with cushioning to enhance comfort.

The bottom layer 16 of the mat cover 12 is designed to interact with the floor when in use. The bottom layer 16 helps grip the floor or otherwise provide some frictional enhancement between the mat cover 12 and the floor. This may be accomplished by the use of a specific material, such as a polymeric or elastomeric material, though various other materials, such as a variety of fabrics may also be used. Additionally, any non-slip materials or non-slip coatings may be used in conjunction with the bottom layer 16. For example, a rubber gel may be applied to the bottom layer 16 to create a grippable, non-slip surface. Additional chemicals, such as adhesives, paints, or sprays, may be applied to the bottom layer 16 to create a non-slip surface. A textured surface may also be provided to the bottom layer 16. For example protrusions, contours, channels, and/or depressions may accompany the bottom layer 16 to increase the amount of friction between the mat cover 12 and a floor.

Various exemplary embodiments include an interior lining 18 provided on the inside of the cover 12 opposite the top layer 14 and/or the bottom layer 16. Similar to the bottom layer 16, the interior lining 18 may be designed to grip or otherwise provide a frictional enhancement between the mat cover 12 and the yoga mat 10. Accordingly, the interior lining 18 may be made from any material or include any of the chemicals, coating, or texture discussed above. The interior lining 18 may also protect the mat from unsanitary conditions such as sweat, moisture, germs, bacteria, fungus, etc. For example, the interior lining 18 may be made from a water-proof and antibacterial material. The interior lining 18 may also be made from a plastic or other polymer material, as well as any natural or synthetic material. The interior lining 18 need not be identical opposite the top layer 14 and the bottom layer 16. For example, the interior lining 18 opposite the top layer 14 may include a water proof material or coating, while the interior lining 18 opposite the bottom layer 16 need not. In an exemplary embodiment, the interior lining 18 includes an absorbent material while the top layer 14 includes a moisture wicking material designed to transfer moisture accumulated on the top layer 14 away from a user. This may assist in keeping the user dry and presenting sanitary conditions. Additional padding, material, or other elements, for example cushioning, may be placed between the interior lining 18 and either the top and bottom layers 14, 16 as needed or desired.

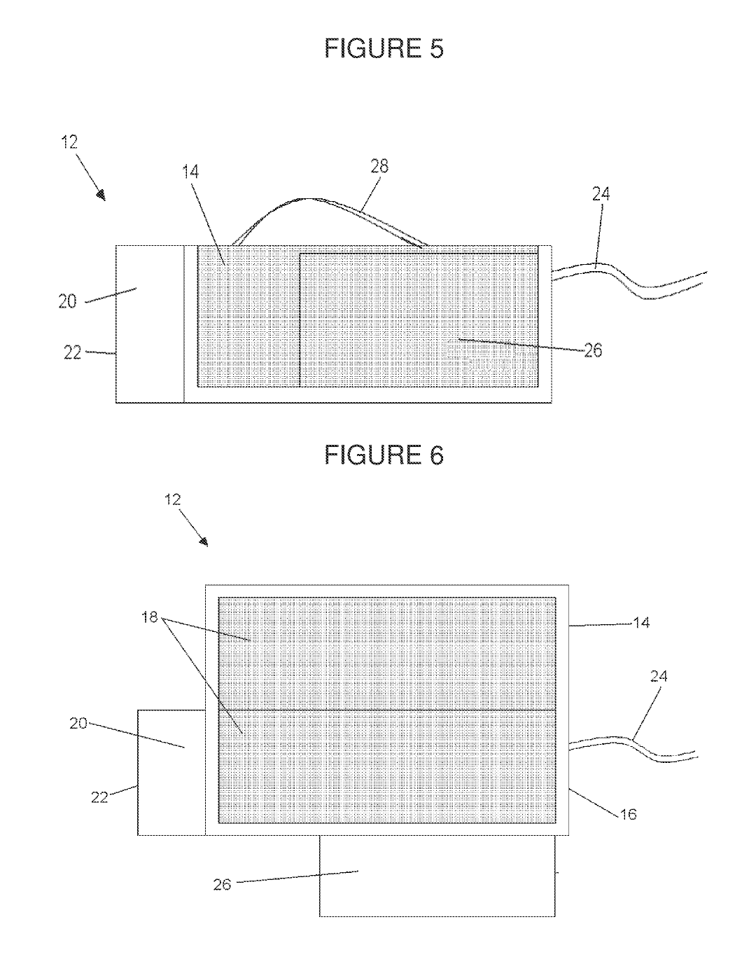

As best shown in FIG. 5, various accessories may be included with the mat cover 12. A pillow 20 may be used during yoga to support different parts of a user's body, for example seated poses or headstands. The pillow 20 may also be used for comfort during relaxation or meditation. The pillow 20 may be made of any soft material known in the art, included but not limited to cotton, foam, gel, feathers, or any soft textile or synthetic material. The pillow 20 may also be inflatable so that it is filled with air by a user when a cushion is needed. In that case, it would include a nozzle or other inflating means (not show) for inflating or deflating via pump or breath. An outer pillow cover 22 may be associated with the pillow 20. The pillow cover 22 may be made of the same material as any other component of the mat cover 12, or it may be made of a different material. The pillow 20 and pillow cover 22 may be separate or an integral unit. The pillow 20 and the pillow cover 22 may be permanently attached to the mat cover 12 or it may be releasably secured through a zipper, buttons, hook and loop, magnet, or any other fastening method or combination thereof. The pillow 20 and pillow cover 22 may also be repositionable around the mat cover 12 so that various configurations can be achieved by a user or it may be folded into the interior of the mat cover 12 or placed in a pocket in the mat cover 12 during use.

A yoga belt 24 may also be provided with the cover 12. The belt 24 can assist a yoga practitioner in stretching and obtaining certain poses. The belt 24 may be made from a variety of suitable materials, such as fabric materials including nylon and cotton. The belt 24 may be of any width and length and may also be flexible. In an exemplary embodiment, the belt 24 may be attached to the mat cover 12 either permanently or releasably, for example, through a threaded connection, buttons, zippers, or hook and loop fasteners. A pocket also may be provided on the mat cover 12 to fit the belt 24 or other objects. Various other straps, retaining means, and methods for releasably connecting the belt 24 to the mat cover 12 may also be used.

As best shown in FIGS. 5 and 6, the cover may include a blanket 26. During meditation, a practitioner may lie on their yoga mat 10 and cover themselves with a blanket 26 to keep warm. As with the belt 24, the blanket 26 may be releasably or permanently attached to the mat cover 12. In an exemplary embodiment, the blanket 26 may fold under the mat cover 12 or into the interior of the cover 12 after the cover is placed over a mat 10. In this way, the blanket 26 will stay clean during a yoga session prior to meditation. The blanket 26 may then be unfolded or removed and used as desired.

The mat cover 12 may also include a carrying strap 28. The strap 28 may be releasably or permanently secured to the mat cover 12 using any fastening elements or methods discussed herein. The strap 28 may be placed on the cover 12 to allow a user to easily carry either the mat cover 12 or the mat cover 12 and a yoga mat 10 that have been rolled up. In an exemplary embodiment the cover 12 includes a pocket for holding the strap 28. The strap 28 may be made from any suitable material. In an exemplary embodiment, the strap 28 can double as belt 24 and vice versa.

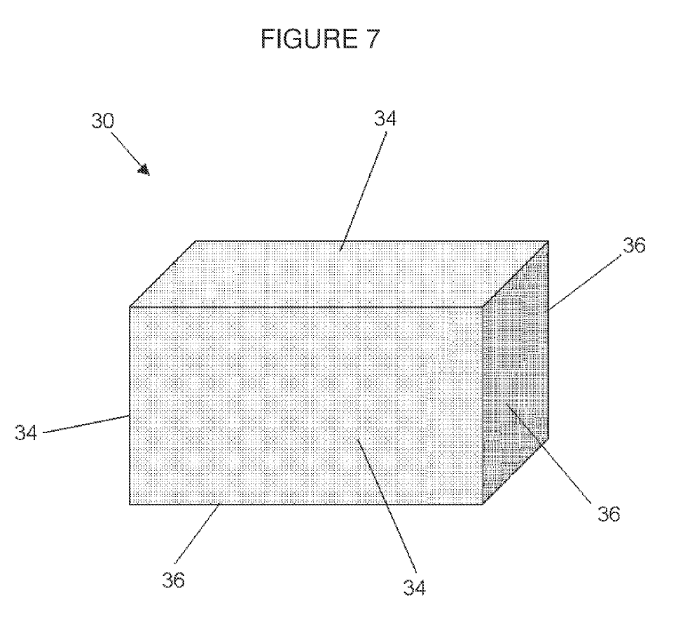

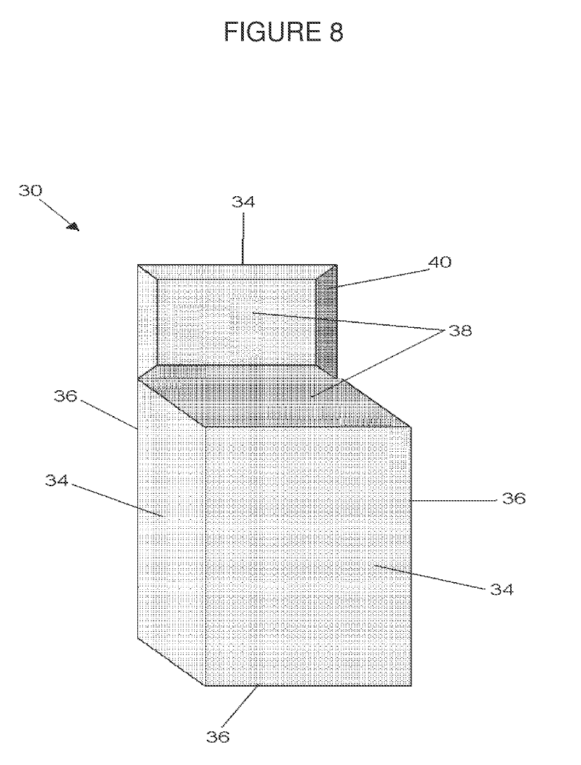

As best shown in FIGS. 7 and 8, in various exemplary embodiments the cover is presented as a block cover 30 sized to fit yoga blocks 32. Blocks 32 are used to assist in a variety of yoga poses. Accordingly, these blocks 32 suffer from the same unsanitary conditions as typical yoga mats 10. The block cover 30 may be made from any of the materials and include any of the features discussed herein with respect to the mat cover 12. As with the yoga mat cover 12, the block cover 30 may be a variety of different sizes and include means to adjust size to fit different blocks. The block cover 30 may include a single top surface 34, a single bottom surface 36, and an interior lining 38. These surfaces 34, 36 may share the same characteristics with the surfaces 14, 16 discussed above. In an exemplary embodiment, the block cover 30 will have alternating top and bottom surfaces 34, 36 as shown in FIG. 7. This configurations allows the block 32 to be used in any position, while still providing an absorbent top surface 34 for contact with a user and a grippable, non-slip bottom surface 36 for contact with the floor. As with the mat cover 12, the block cover 30 may vary in the number of sides which are connected so that different openings may be provided. As best shown in FIG. 8, the block cover 30 may have an end portion 40 which can be opened to allow the insertion of a yoga block.

At home yoga exercise systems, comprising of a yoga mat, blocks, belts and the like, would benefit from the cover 12 by allowing the yoga practitioner to work on a sanitary, comfortable, safe, washable surface. Also, in-studio yoga exercise systems, gyms and other yoga classes, would benefit from the present invention by allowing the yoga practitioner to work on a sanitary, comfortable, safe, washable surface.

The foregoing detailed description of the certain exemplary embodiments has been provided for the purpose of explaining the principles of the invention and its practical application, thereby enabling others skilled in the art to understand the invention for various embodiments and with various modifications as are suited to the particular use contemplated. This description is not necessarily intended to be exhaustive or to limit the invention to the precise embodiments disclosed. Additional embodiments are possible and are intended to be encompassed within this specification and the scope of the appended claims. For example, the covers discussed above may be modified to work with a variety of yoga and exercise equipment. The specification describes specific examples to accomplish a more general goal that may be accomplished in another way.

Only those claims which use the words “means for” are to be interpreted under 35 U.S.C. 112, sixth paragraph.

What is claimed:

1. A cover for yoga equipment comprising:
a top layer for contacting a user;
a bottom layer for contacting a floor; and
an interior lining opposite at least one of the top layer and the bottom layer,
wherein the top layer and the bottom layer may be placed to define an opening therebetween to receive a piece of yoga equipment.

2. The cover of claim 1, wherein the top layer comprises an absorbent material.

3. The cover of claim 1, wherein the bottom layer comprises a non-slip surface.

4. The cover of claim 1, wherein the interior lining comprises a water-proof material.

5. The cover of claim 1, wherein the interior lining comprises an absorbent material and the top layer comprises a moisture-wicking material.

6. The cover of claim 1, wherein the cover is machine-washable.

7. The cover of claim 1, wherein the top layer and the bottom layer are permanently connected on at least one side.

8. The cover of claim 1, wherein the top layer and the bottom layer are releasably connected on one side.

9. The cover of claim 1, wherein the top layer comprises a first exterior surface and an first interior surface and the bottom layer comprises a second exterior surface and a second interior surface, the first and second interior surfaces comprising a non-slip material.

10. The cover of claim 1, wherein the top layer is a first top layer and the bottom layer is a first bottom layer and the cover further comprises second and third top layers and second and third bottom layers.

11. A yoga equipment system comprising:
a yoga mat; and
a cover for the yoga mat comprising a top surface for contacting a user, a bottom surface for contacting a floor, and an interior lining contacting the yoga mat,
wherein the top surface and the bottom surface may be placed around the yoga mat.

12. A method of using a yoga mat cover comprising:
placing a cover around a yoga mat, the cover comprising a top surface for contacting a user, a bottom surface for contacting a floor.
